(19) United States
(12) Patent Application Publication
(10) Pub. No.: US 2009/0080753 A1
(43) Pub. Date: Mar. 26, 2009

(54) Radiography image processing method

(76) Inventors: Mattieu Stefan De Villiers, Cape Town (ZA); Craig Haworth, Sandton (ZA); Carlos Manuel De Seabra Sousa, Johannesburg (ZA); Johannes Hermanus Potgieter, Midrand (ZA)

Correspondence Address: SCULLY SCOTT MURPHY & PRESSER, PC, 400 GARDEN CITY PLAZA, SUITE 300, GARDEN CITY, NY, 11530, US

(21) Appl. No.: 11/918,538

(22) PCT Filed: Apr. 12, 2006
(86) PCT No.: PCT/IB2006/000872

§ 371 Date: May 9, 2008

(30) Foreign Application Priority Data
Apr. 13, 2005 (ZA) 2005/02961

(51) Int. Cl. G06K 9/00

(52) U.S. Cl. 382/132

(57) ABSTRACT

A radiography image processing method includes obtaining an image of a body being examined. The intensity of each of a plurality of areas of the image are determined and the intensity of each of the plurality of areas of the image are used to determined a respective contrast range to be applied selectively to each of said areas of the image. The determined contrast range is then applied to each of said areas of the image thereby to obtain a processed image having relatively uniform contrast ranges in areas of differing intensity.

### BACKGROUND OF THE INVENTION

This invention relates to a radiography image processing method, particularly to a method of processing an X-ray image.

Two basic types of imaging apparatus for human and animal diagnosis are known. The first uses an x-ray source which illuminates the whole of the area under examination. For human application, this is often referred to as full field, or when the whole body is to be examined, a whole body examination.

The second type of apparatus is a scanning x-ray system for which the x-ray source and the detector are moved relative to the subject under examination, in order to generate a composite image of the subject. Such a system is disclosed in International patent application no. WO 00/53093.

The x-ray detector system may be conventional film, or can be scintillator arrays optically linked to charge coupled devices (CCD's). The latter is the system used in the scanning system described in the above-mentioned International patent application, in which the x-ray source is mounted on one end of a C-shaped arm, and the scintillator arrays are mounted on the opposite end of the C-arm. In such a scanning system, it is preferable that the x-rays are highly collimated by a single slit, the resulting x-ray beam is a narrow “fan-beam” of x-rays of typical width of 3 to 6 mm (medical imaging application), and which extends the full width of the scanning system, up to 850 mm.

X-ray images have a very large dynamic range. This makes it very difficult to view regions of high attenuation and low attenuation comprehensively on a single display. A specific example is in a scanning x-ray image of a full body, where it is difficult to see the hand and the skull simultaneously as these two parts of the body have different levels of x-ray attenuation and are therefore represented on the image as different intensity range.

A common method to address this problem is called “window & level”. This means that the user can select a range of intensity values that are to be viewed (the window), and can then adjust the position of the window and the size (width of the window) to view those intensity values. The software therefore simply remaps the actual intensity values to a range which is visible. On a standard computer the visible range is defined as 256 grey levels and a palette is defined which maps the whole 14-bit or 16-bit range, or the selected window width to this visible range. The palette is therefore the transform map of image intensities to visible grey level intensities. This palette is also dynamic and changed according to the user requirement of the window position (level) and the window width.

Contrast between intensities can be visibly improved by reducing the window width, or smoothed out by stretching the window. This means that two regions with very similar gray scale can be distinguished from each other by sharpening up the contrast. That is reducing the width of the gray scale window. The gray scale window width is a way of controlling the image contrast and represents to the image's “clarity” to a viewer. The gray scale window level refers to the image's “visibility” to a viewer. It will be noticed that the thinner area of the body, for example the hand, will be much lighter than a larger area such as a pelvis. By adjusting the Gray Scale level, the area of interest can be brought into view.

The object of the present invention is to provide an imaging processing method which can be applied to digital images from a radiography system, particularly a scanning system, to address the above problems.

### SUMMARY OF THE INVENTION

According to a first aspect of the invention there is provided a radiography image processing method including:
obtaining an image of a body being examined;
determining the intensity of each of a plurality of areas of the image;
using the intensity of each of the plurality of areas of the image to determine a respective contrast range to be applied selectively to each of said areas of the image; and
applying the determined contrast range to each of said areas of the image,
   thereby to obtain a processed image having relatively uniform contrast ranges in areas of differing intensity.

The image may be a low resolution image of the body being examined.

The contrast range may be determined by determining upper and lower contrast values.

The upper and lower contrast values may be assigned to each of a plurality of coordinates of the image of the body being examined.

The contrast range may be applied to each of the areas of the image by applying the contrast range to each pixel or binned pixels in the area of the image being processed.

In one example, the image may be processed further by bilateral filtering which is carried out where contrast settings do not vary smoothly from one area to the next.

The image may also be processed further by noise reduction.

In one example, the image is processed further by edge sharpening, which may be performed using unsharp masking.

The method is typically carried out by software executing on a processor associated with the radiography imaging system.

### BRIEF DESCRIPTION OF THE DRAWINGS

FIG. 1 is a pictorial view of a radiological scanning x-ray system;

FIG. 2 shows the basis of dynamic range compression used by the algorithm to view all sections of the body under examination in a scanning x-ray system; and

FIG. 3 is a flowchart showing an example method of imaging.

### DESCRIPTION OF AN EMBODIMENT

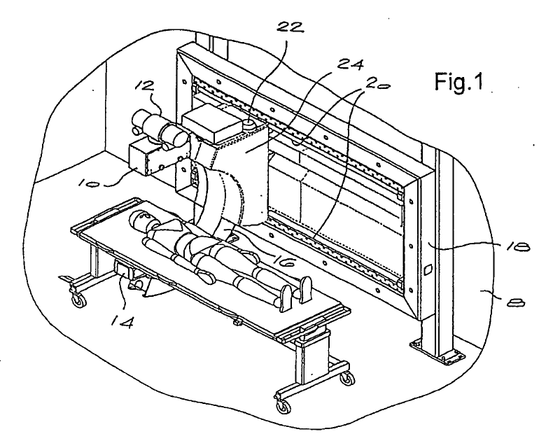

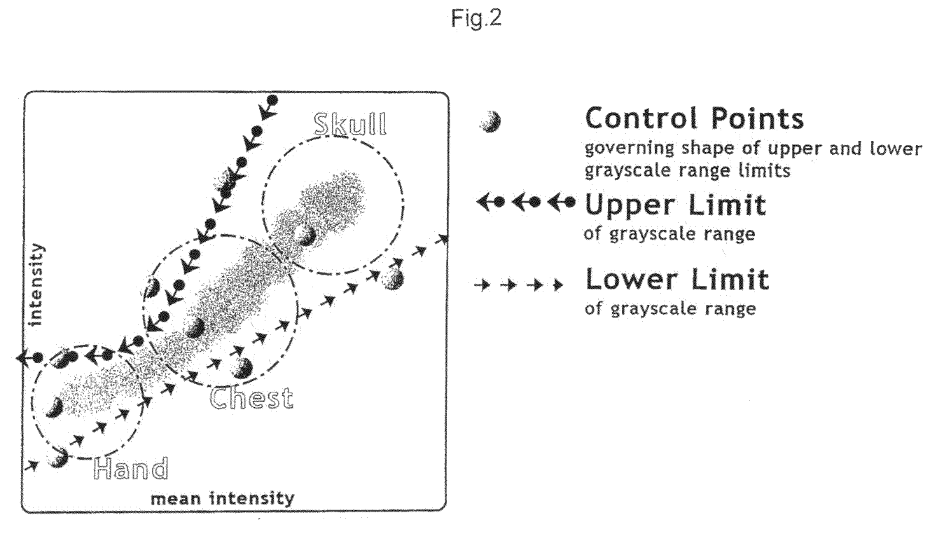

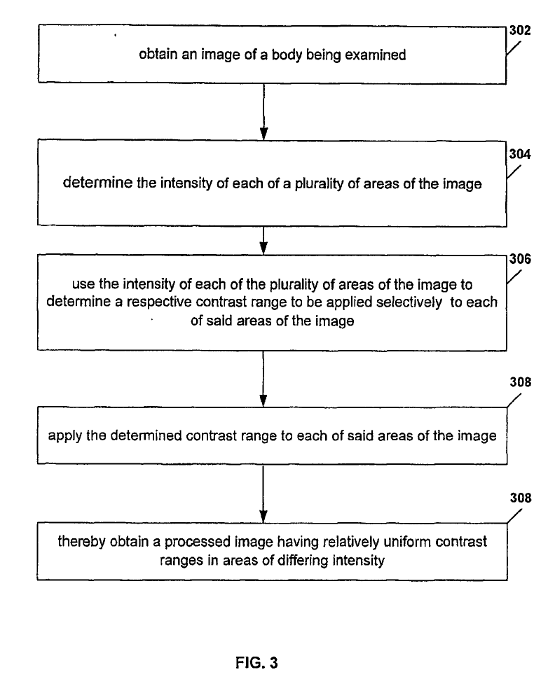

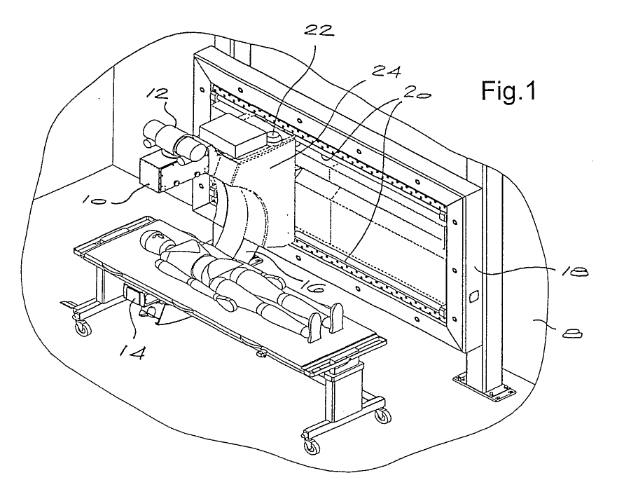

FIG. 1 shows an example of a radiological scanning apparatus. The apparatus comprises a head 10 containing an X-ray source 12 which emits a narrow, fanned beam of X-rays towards a detector unit 14. The X-ray source 12 and the detector unit 14 are supported at opposite ends of a curved arm 16 which is generally semi-circular or C-shaped.

A frame 18 mounted on a wall 8 or another fixed structure defines a pair of rails 20 with which a motorised drive mechanism 22 engages to drive the arm linearly back and forth in a first, axial direction of movement. This corresponds to the direction of scanning in use. In addition, the drive mechanism comprises a housing 24 in which the arm 16 is movable by the drive mechanism in order to cause the X-ray source and the detector to rotate about an axis parallel with the scanning direction of the mechanism.

A typical application of the imaging apparatus of the invention is in a radiological installation which will include positioning consoles by means of which an operator can set up the required viewing parameters (for example, the angle of the arm 16, start and stop positions, and the width of the area to be X-rayed) and a main operator console which is used by the operator to set up the required radiographic procedure. The imaging apparatus is operated to perform a scan of a subject supported on a specialised trolley or gurney

The apparatus described above is generally similar to that described in International patent application no. WO 00/53093, the contents of which are incorporated herein by reference.

It will be appreciated that while an example methodology will be described in the context of the above apparatus, the methodology finds application in other imaging apparatus.

In any event, referring back to the FIG. 1, the X-ray source (tube) 12 emits a low-dose collimated fan-beam of X-rays. The X-ray detector unit 14 fixed to the other end of the C-arm 16 comprises a set of scintillator arrays optically linked to respective charge-coupled devices (CCDs). An image is acquired by linearly scanning the C-arm over the length of the subject (patient) 32 with the X-ray source active, whilst continuously reading the outputs of the detector unit in a mode analogous to “scrolling”, thus building up a composite image.

In an example system, the individual pixels of the detector unit have a 60-micron size, providing up to 14336 elements along the length of the detector. This defines the width of the area to be scanned. Spatial resolutions of 1.04 to 8.33 line pairs per millimeter (lp/mm) are selectable in discrete steps. The system can record 14 bits of contrast resolution (>16383 grey scales) which compares favorably to the typically 1000 grey scales that can be detected on a conventional x-ray film under ideal viewing conditions. The C-arm is able to rotate axially around the patient to any angle up to 90 degrees, permitting horizontal-beam, shoot-through lateral, erect and oblique views.

The C-arm travels at speeds of up to 144 or 200 mm per second. The device is thus able to rapidly acquire images of part or all of the body of a patient, with a full body scan requiring 13 seconds (medical application) and 10 seconds for the screening application; and with smaller areas requiring proportionately less time.

As indicated above, the system makes use of the technological principle sometimes referred to as “slit (or slot) scanning” and in this case, specifically “linear slit scanning”. The detector is based on CCD technology running in the so-called “drift scanning”, alternatively “TDI” (time-division integration) mode.

The X-rays emitted by the source 12 are highly collimated by a single slit that irradiates the detector with a narrow “fan beam” of x-rays. The fan beam is “narrow” (3 mm-6 mm thick for medical) in the scanning direction and “wide” (˜696 mm—medical application/˜812 mm—screening application) in a direction transverse to the scanning direction. For applications where a fixed slit/slot is used the fan beam thickness is optimized for the application, example 10-11 mm for the screening application.

If the fundamental pixel size at the detector front (X-ray detecting) face were 60 μm, then, according to the well known formula:

Spatial resolution=1/(2×pixel-size)lp/mm

a fundamental spatial resolution of 8.33 lp/mm would be obtained.

By combining (binning) the fundamental pixels into super pixels larger effective pixels are created. For example, super pixels could be formed by adding the output signals from orthogonal sets of adjoining fundamental pixels. Typical examples would be:

| | System “mode” designation: | | | |
|---|---|---|---|---|
| | Very | | | |
| | High | High | Standard | Base |
| Array dimension of | 2 × 2 | 3 × 3 | 5 × 5 | 8 × 8 |
| fundamental pixels | | | | |
| Spatial resolution (lp/mm) | 4.17 | 2.78 | 1.67 | 1.04 |
| Relative SNR per super pixel | 2 | 3 | 5 | 8 |

Note that for a fixed signal (i.e. X-ray flux) per unit area to be detected, the smaller the area resolved (i.e. size of effective pixel), the higher the spatial resolution that will be obtained. However, the smaller the area resolved (i.e. size of super pixel), the lower the SNR (signal to noise ratio) that could be obtained. The SNR directly affects the contrast resolution (ability to see small differences in grey scales) of the system. Thus, bigger pixels per unit input signal yield a better contrast resolution.

There are several other factors that impact on the usefulness of the image to ensure that diagnosable X-rays are obtained.

As mentioned above, X-ray images have a very large dynamic range. This makes it very difficult to view regions of high attenuation and low attenuation comprehensively on a single display such as in the scanning x-ray image of a full body produced by the system described above. In such an image it will be noticed that the thinner area of the body, for example the hand, will be much lighter than a larger area such as a pelvis. In such a case it is difficult to see the image of a hand if the contrast and brightness settings are chosen to view the details of the pelvis.

In an example method, the above described problem of overcoming the large dynamic range of brightness in x-ray images thereby enabling the satisfactory viewing of images from areas of both high and low attenuation is addressed using dynamic range compression. This is achieved by applying an algorithm that enables all parts of the image to be viewed equally successfully despite the large variations in intensity of the original image. In doing such a modification to the digital image, no value or information content of the original image is lost.

In order to illustrate the algorithm, consider three regions being the head, the lungs and the hands. The average brightness of pixels in the head region is high, for example, an intensity value of 7000 greyscale units (which is a relative scale, i.e. 7000 in 16383), for the lungs medium (4000 greyscale units) and for the hands low (2000 greyscale units). Each of these different regions would be viewed best over a different window range of grey levels, for example, the skull area would be best viewed in a range 5000-9000 greyscale units, the lungs 3000-6000 greyscale units and the hands 1000-4000 greyscale units.

The aim of the algorithm is to stretch the intensity contrast range of these regions differently, as described above, but in a seamless manner.

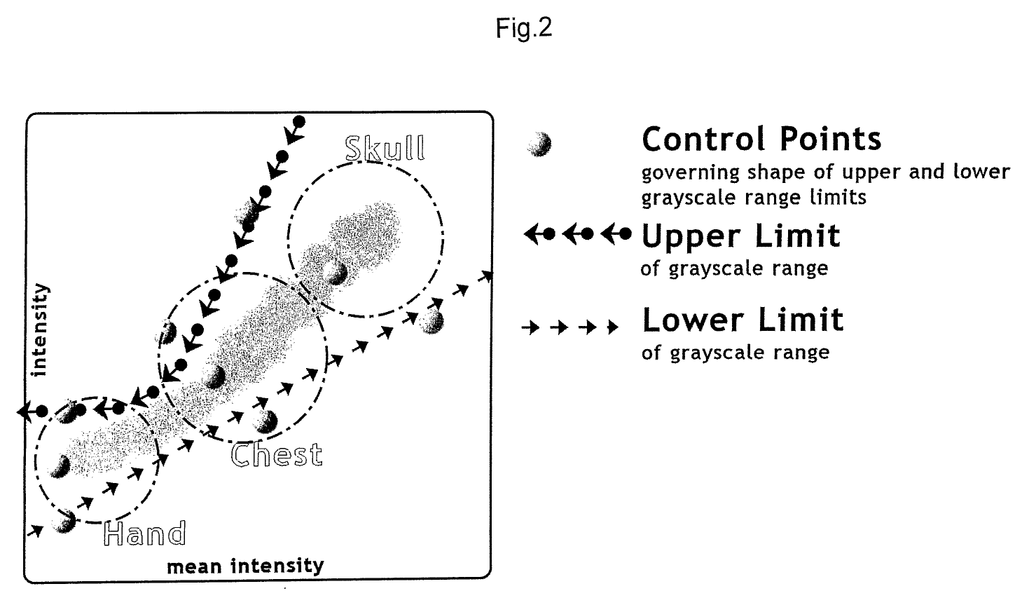

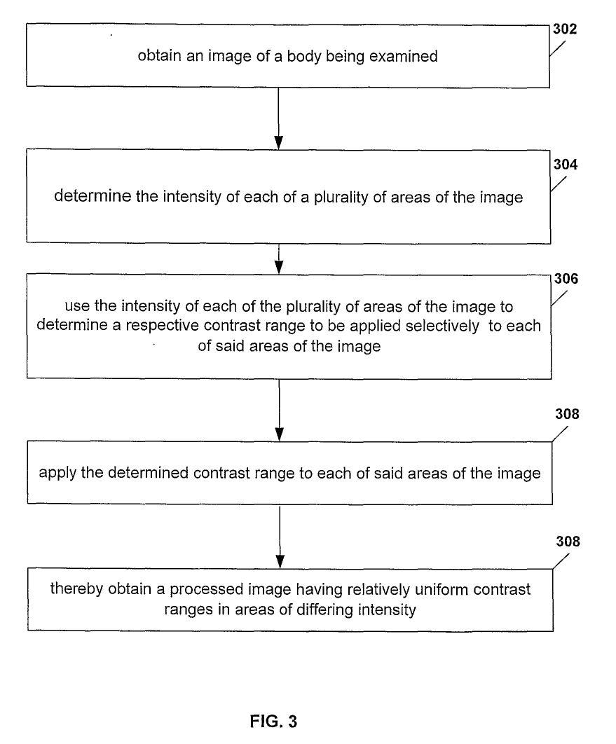

Contrast stretching means that a greyscale range, say 1000-4000, is scaled and/or shifted to another range, say 8000-10000. The method described below achieves a similar principle but considers local image areas before deciding on what level of contrast stretching is required. This is done in the following manner. A blurred or relatively low resolution image is created of the body being examined, using a relatively large pixel size, by combining the individual pixels of the digital image in a 5×5 array, for example. This can be done efficiently by first accumulating the image of the body by scanning in both directions, and a scatter plot of all the large pixel's intensity readings as a function of coordinates plotted, as shown in FIG. 2.

From this plot, upper and lower contrast values are assigned to each coordinate of the image of the body being examined. Then, each individual pixel in the digital image is contrast stretched individually using the data obtained from the blurred image, and plotted as shown in FIG. 2 as the contrast range curves.

The consequence of this is that, when a high resolution image is formed by scanning with the appropriate combination (binning) of the individual pixels, the reading for each pixel or binned pixel is modified by the contrast range setting, given by the algorithm, for that pixel or binned pixel. The result is that an evenly attenuated image of the whole body, with relatively uniform contrast, is obtained.

In applying the algorithm above, shadows are created around the edges of certain parts of the body, because of the use of the same contrast stretch settings close to the edge as in the interior. This causes over-stretching near interfaces. To overcome this, bilateral filtering is carried out where the contrast settings do not vary smoothly from one region to the next. Bilateral filtering is a simple, non-iterative scheme for edge-preserving smoothing, which is widely described in literature.

A problem with bilateral filtering is that it can, in fact, over-sharpen edges in the 1-2 pixel resolution range. This can, however, be alleviated by blurring the image slightly (that is, combining more pixels).

Denoising or noise reduction is carried out in conjunction with the dynamic range compression algorithm described above. The denoising reduces the occurrence of faulty pixels which occur randomly and have either abnormally high or abnormally low intensities. Only single faulty pixels are detected and removed. When two or more adjacent faulty pixels occur, only one is improved. For a faulty pixel, that is, its intensity is extreme, its value is replaced with the value of the third highest intensity in a 3×3 region of pixels around the faulty pixel, for example, if it had an abnormally high intensity, and by the third lowest value if its intensity was abnormally low. The algorithm for doing this did not blur the images noticeably in the prototype of the present invention. However, to compensate for any slight blurring do to denoising, and to enhance edges further, edge sharpening is performed using standard unsharp masking.

The above methodology is performed by software executing on at least one processor associated with the radiography system. The software can form part of a post-processing algorithm on the viewing system workstation or can be performed as an integrated processing algorithm during the image acquisition and correction process in the image pre-processor, for example.

1. A radiography image processing method including:
obtaining an image of a body being examined;
determining the intensity of each of a plurality of areas of the image;
using the intensity of each of the plurality of areas of the image to determine a respective contrast range to be applied selectively to each of said areas of the image; and
applying the determined contrast range to each of said areas of the image,
thereby to obtain a processed image having relatively uniform contrast ranges in areas of differing intensity.

2. A radiography image processing method according to claim 1 wherein the image is a low resolution image of the body being examined.

3. A radiography image processing method according to claim 1 wherein the contrast range is determined by determining upper and lower contrast values.

4. A radiography image processing method according to claim 3 wherein the upper and lower contrast values are assigned to each of a plurality of coordinates of the image of the body being examined.

5. A radiography image processing method according to claim 1 wherein the contrast range is applied to each of the areas of the image by applying the contrast range to each pixel or binned pixels in the area of the image being processed.

6. A radiography image processing method according to claim 1 wherein the image is processed further by bilateral filtering which is carried out where contrast settings do not vary smoothly from one area to the next.

7. A radiography image processing method according to claim 1 wherein the image is processed further by noise reduction.

8. A radiography image processing method according to claim 1 wherein the image is processed further by edge sharpening.

9. A radiography image processing method according to claim 8 wherein the edge sharpening is performed using unsharp masking.

10. A radiography image processing method according to claim 1 wherein the method is carried out by software executing on a processor associated with the radiography imaging system.
